(19) United States
(12) Patent Application Publication
(10) Pub. No.: US 2021/0190939 A1
(43) Pub. Date: Jun. 24, 2021

(54) SYSTEM AND METHOD FOR FACILITATING POSITION TRACKING

(71) Applicant: Yoon Phil Kim, Wayland, MA (US)

(72) Inventor: Yoon Phil Kim, Wayland, MA (US)

(21) Appl. No.: 16/722,638

(22) Filed: Dec. 20, 2019

(51) Int. Cl. G01S 13/87; G01S 17/87; G01S 1/44

(52) U.S. Cl. CPC G01S 13/878; G01S 1/44; G01S 17/87

(57) ABSTRACT

Disclosed are a system for identifying the position of mobile object, comprising a positioning module, a set of beacons and processor configured to determine the position of the positioning module based on the data gathered from the interaction between the positioning module and each one of the set of beacons. More specifically, the positioning system utilizes signal emitted from the beacons and the signal emitted from the positioning module in response to receiving the signal from the beacon. Using the signals transmitted from the positioning module and the beacons, vectors of signals from the bacons to the positioning module are obtained, and the intersecting point of the vectors of those signals is identified as the position of the positioning module.

### FIELD OF THE INVENTION

The invention relates to a method and a system for tracking position of an object, and more particularly relates to positioning and navigation control system based on directional signal scanning and measurement method.

### BACKGROUND OF THE INVENTION

Various known navigation and positioning systems enable people in cars, boats, aircraft, and other moveable objects to efficiently travel between given locations. Knowing a precise current geographic location or starting location and a desired destination or ending location enables navigation systems to provide customized directions that indicate which direction that moveable object should travel to reach the destination or ending location. Various known navigation systems use path-planning algorithms that combine knowledge of conduits (such as streets, bridges, or traffic rules), obstacles (such as freeway congestion), and current real-time positioning information to determine and output detailed directions.

Various known navigation systems are enhanced through graphical user interfaces that visually depict the surroundings of a current position, identify points of interest, and provide a highlight of a path of travel to reach a destination. In one known example, vehicular navigation systems use the Global Positioning System (widely known as GPS). GPS is a space-based global navigation satellite system (GNSS) that provides reliable location and time information to anyone on or near the earth.

One known limitation of existing navigation systems that employ GPS is that they typically need an unobstructed line of sight to multiple (such as four or more) GPS satellites to receive and calculate a geographic position of an object. For this reason, GPS typically does not effectively operate in indoor areas or spaces such as in buildings or other covered structures. Thus, while GPS has become a valued system for outdoor navigation, GPS is generally not ideal for indoor navigation application.

Various existing indoor navigation systems use radio or sound waves to determine a current position of a moveable object within an indoor area. One known indoor navigation system determines a location using Received Signal Strength Indicator (“RSSI”) values of multiple Wi-Fi beacons (i.e., IEEE 802.11 access points or radios). This system is configured to use location fingerprinting, which stores samples of RSSI values of received Wi-Fi signals transmitted by a number of locations in a pre-mapped area. In this location fingerprinting system, a processor computes a current location of a moveable object by sampling the RSSI values and performing a look-up search from a database.

Another known indoor navigation system determines a location of a moveable object using triangulation of RSSI values of multiple Wi-Fi beacons. This system uses triangulation to compute expected signal strengths at a given location using signal propagation equations that estimate effects of known obstructions and multipath errors.

One known problem of using location fingerprinting or triangulation in indoor areas is that both of these methods are limited in accuracy to within a few meters, and tend to worsen with dynamic changes in signal obstructions resulting from human movement or physical obstructions, including for example, walls, shelves, signs, etc. Similar indoor positioning and navigating methods relying on Bluetooth signal or Near Field Communication (“NFC”) signals also experience the same challenges in indoor areas.

Since all of these navigation systems have various known issues or problems, the overall need for navigation systems remains an issue largely unaddressed by currently known commercially available navigation systems. Accordingly, a need exists for a new navigation system that does not rely on a satellite or unreliable characteristics of a signal such as signal strength.

### SUMMARY OF THE INVENTION

Accordingly, example embodiments of the present disclosure are provided to substantially obviate one or more problems due to limitations and disadvantages of the related art. Various embodiments of the present disclosure solve the above problems by providing a precise and accurate limited area positioning system that utilizes the location of the beacons and the angle in which the positioning module is located relative to a set of beacons.

Generally, a limited area positioning system includes a positioning module, at least two beacons and a processor that is configured to determine the position of the positioning module based on the data gathered from the interaction between the positioning module and each one of the set of beacons. More specifically, the limited area positioning system utilizes a beacon signal emitted from each of the beacons, and may further utilize a module signal from the positioning module, which may be emitted in response to receiving a beacon signal. The coordinate of the positioning module can be identified based on the coordinates of the beacons and the angle of beacon signals emitted from those beacons, which are received at the positioning module. The beacon signal should be a signal that travels in substantially straight line. The limited area positioning system can determine the coordinate of the positioning module based on the coordinates of the beacons and the angle in which the beacon is aligned with the positioning module (i.e., the angle in which the beacon signals from those beacons reaching the positioning module).

One aspect of the present disclosure provides systems for self-positioning within a limited area. Example embodiments of the present disclosure, as limited area positioning system, provide systems for determining coordinate of a positioning module based on coordinates of at least two beacons and the angle in which the positioning module is positioned in relation to those beacons.

In one embodiment, the limited area positioning system comprises a plurality of beacons. Each of the beacons includes a module signal receiver and a beacon signal transmitter. The actuator is coupled to the beacon signal transmitter so that the angle in which the beacon signal emitted from the beacon signal transmitter can be adjusted. The positioning system is further provided with a positioning module. The positioning module includes a beacon signal receiver and a module signal transmitter. The module signal transmitter is configured to emit a module signal in response to receiving the beacon signal. The positioning system is further provided with a processor that is configured to identify the angle in which the positioning module is located in relation to the beacons. In this regard, the relative angle from the beacon can be determined by obtaining the degree of movement of the actuator. To scan the positioning module, the actuator of the beacon continues to adjust orientation of the beacon signal transmitter while the beacon signal transmitter emits the beacon signal, thereby adjusting the emissive angle of the beacon signal that travels substantially in a straight line. When the beacon signal is received by the beacon signal receiver of the positioning module, the module signal transmitter of the positioning module emits the module signal. The actuator's movement stops when the beacon's module signal receiver receives the module signal, and the degree of actuator's movement from the reference position until the receipt of the module signal would be indicative of the angle in which the positioning module is aligned from that beacon. Since the coordinate of each of the beacons are predefined, the coordinate of the positioning module can be identified when the angles from those beacons to the positioning module is determined. In some embodiments, the processor may be configured to identify the coordinate of the location where at least two beacon signals intersect each other as the coordinate of the positioning module. In some other embodiments, the processor may rely on additional beacon signals for verification or for increased accuracy in determining the location of the positioning module. For instance, the processor may be configured to determine the coordinate of the point where at least three beacon signals intersect each other as the coordinate of the positioning module.

The actuator may be implemented with a stepper motor, which is configured to rotate the beacon signal transmitter about the beacon as the axis of that rotation. While the beacon signal must be a signal that exhibit directionality, the module signal need not exhibit directionality. Accordingly, in some embodiments, said beacon signal is a laser based signal or an infrared based signal. In some embodiments, the module signal is a radio frequency based signal. The positioning system may be provided with a database, which stores a look-up table of coordinates that corresponds to a set of potential intersecting points of the beacon signals emitted from the beacons. The database may be provided in the positioning module itself. In some other embodiments, the database storing the look-up table of coordinates that corresponds to a set of potential intersecting points of the beacon signals is provided on a network server. In this case, each of the beacons is provided with a network module to communicate with the network server to provide beacon's unique identification information, unique identification information of the positioning module associated with the module signal received by the module signal receiver, and the angle of which the beacon signal travels from the respective beacon to the positioning module.

In another embodiment, the positioning system is provided with a plurality of beacons, and each beacon is provided with a plurality of beacon signal transmitters. Each of the beacon signal transmitters is configured to transmit a beacon signal in predefined angles about the respective beacon. In other words, each beacon may consists of N number of beacon signal transmitters, and each of the beacon signal transmitter may be configured to transmit the beacon signal in a range of 360/N degrees angle. Each of the beacon signal transmitters may be dedicated to emit the beacon signal in a predetermined limited range of angles. The range of angles covered by one of the beacon signal transmitters may not overlap with the range of angles covered by another one of the beacon signal transmitter of the same beacon. It is preferred that the plurality of beacon signal transmitters provided in a single beacon, collectively, covers the entire 360 degrees about the respective beacon. In this embodiment, the beacon signal may be designed such that it identifies where that beacon signal originates from (i.e., the identification of the beacon as well as the identification of the specific beacon signal transmitter within that beacon). Since each beacon signal transmitter emits the beacon signal only in a predetermined direction (i.e., angle), the identification of the beacon and the identification of the beacon signal transmitter obtained from the beacon signal can indicate the angle in which the beacon is positioned from the positioning module. The beacon's coordinate is already known, and with the emission angle of the beacon signal from that beacon towards the positioning module, the coordinate of the point where the beacon signals from at least two distinct beacons intersect each other (i.e., the coordinate of the positioning module) can be identified. Further, the positioning system can be configured to determine the coordinate of the point where more than two beacon signals intersect each other, for instance at least three beacon signals, as the coordinate of the positioning module. The intersecting point of the vector of the beacon signals is the location of the positioning module. A hash map of angles and coordinates of the corresponding intersecting point of the vectors of the beacon signals are pre-calculated and stored in a database (look-up table). Accordingly, the processor can identify the coordinate of the positioning module by querying a set of beacon signal transmitter identifications received by the positioning module.

In this embodiment, the beacon signal is structured such that it identifies the beacon as well as the beacon signal transmitter where that beacon signal is originated from. The coordinate of the beacon is known, and the identification of the beacon signal transmitter gives away the vector (i.e., emission angle) of the beacon signal emitted from that beacon. In other words, the beacon signal already incorporates the information regarding the angle in which the beacon is positioned relative to the positioning module or the angle in which the positioning module is positioned relative to the beacon associated with that beacon signal. Accordingly, the positioning module does not need to transmit a module signal back to the beacons for determining the angle. Moreover, the beacons do not need to wait for the module signal or actively engage in calculating a coordinate of a positioning module. The beacons only need to transmit the beacon signals, and the coordinate calculation is handled by either the positioning module itself or by a remote server based on the beacon signal information collected by the positioning module. This allows for faster scanning of the positioning module while reducing process power consumption.

### BRIEF DESCRIPTION OF THE DRAWINGS

FIG. 1 is a functional schematic diagram of a positioning system of one example embodiment of the present disclosure.

FIG. 2A is a functional schematic diagram of a positioning system of one example embodiment using beacons coupled to an actuator.

FIG. 2B is a flowchart illustrating a method of determining the position of the positioning module according to the embodiments described in FIG. 2A.

FIG. 3A is a functional schematic diagram of a positioning system of one example embodiment using beacons with a plurality of beacon signal transmitters provided therein.

FIG. 3B is a flowchart illustrating a method of determining the position of the positioning module according to the embodiments described in FIG. 3A.

### DETAILED DESCRIPTION OF THE INVENTION

Hereinafter, the present invention will be described in more detail with reference to the following Examples. However, these Examples are set forth to illustrate the present invention, and the scope of the present invention is not limited thereto.

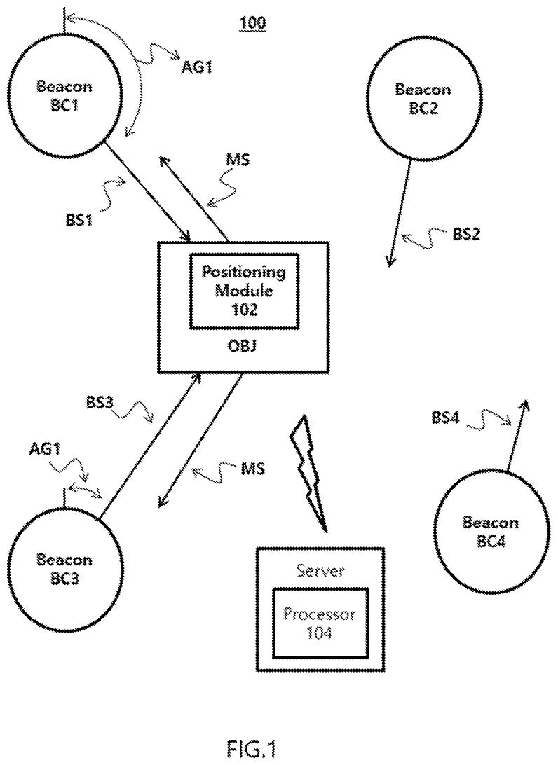

Turning now to the drawing, FIG. 1 shows a functional schematic diagram of one embodiment of a positioning system 100 of the present disclosure that accurately and precisely determines a current location of a movable object OBJ. The limited area can be any suitable indoor area such as, but not limited to, a retail or wholesale store (such as a grocery store), a megastore, a shopping mall, a museum, a school, a hospital, an office building, a residential building, an indoor amusement park, and a storage warehouse. In addition, the limited area may also be certain partially enclosed or restricted outdoor areas (e.g., urban canyons, college campuses, railway stations, etc.), which certain mobile devices may have difficulties in reliably receiving or acquiring sufficient satellite or cellular wireless signals to facilitate or support one or more conventional satellite signal dependent position estimation techniques. Being in a near enclosed space, such as a steep sided valley or a high rise urban environment, reduces the area of sky visible to the GPS receiver. In such situations, the number of satellites that are in direct line of site of the receiver is reduced. Also, receiving GPS signals from a disperse set of satellites is prevented. That is, the satellites used to calculate your location are clustered within a small area of the sky. Highly clustered satellites can result in large positional errors, even up to several hundred meters. Unlike the conventional satellite based GPS, the limited area positioning system 100 described in the present disclosure offers millimeter scale accuracy in near closed environment or even indoors.

For instance, in a shopping mall or grocery store environment, the positioning system 100 can provide assistance to customers in locating their desired items within the store. In this embodiment, the movable object OBJ could be a cart that can move around within the store or a device that is carried by a user. The movable object OBJ can be equipped with a means to display to a user the location where the supplies are stocked and help users to navigate toward the designation. The positioning system 100 can also show a navigation route or turn-by-turn directions to areas of the shopping mall or the grocery store where the desired items are located. The positioning system 100 can also track when the user puts the desired items from the shelf to the cart at a location and update the navigation route or directions within the limited area (e.g., shopping mall or grocery store). For instance, the positioning system 100 may be configured to scan the RFID of the item when the movable object OBJ (e.g., cart) reaches the shelf where the item is at.

In another embodiment, the positioning system 100 could be used to guide users through a museum. In this embodiment, the positioning system 100 displays a navigation route or turn-by-turn directions to different exhibits in a museum. The positioning system 100 can also enable a user to search for a particular exhibit and display a navigation route or directions to reach the exhibit. The positioning system 100 can also display more information about the exhibit when it detects the user is in proximity to an exhibit.

The application of the positioning system 100 is not just limited to indoor environment, but could be used in outdoor areas. For instance, the positioning system 100 of the present disclosure can be used for street vehicle navigation in urban areas so long as beacons can be placed in that area or region. Of course, the movable object OBJ is not limited to a vacuum robot, but may also be lawnmower, air purifier or any other machine, which features automatic maneuvering ability within a scanning area.

In the illustrated exemplary embodiments, the positioning system 100 includes a set of beacons 102A-102D, a positioning module 104, and a processor 106. The positioning module 104 is configured to communicate with the set of beacons 102A-102D and identify its position in relation to the position of the set of beacons. The positioning module 104 may be coupled to the movable object OBJ, or in some embodiments, the positioning module 104 may be a part of the movable object OBJ. Accordingly, the position of the positioning module 104 changes as the movable object OBJ moves within the scanning area. Each of the beacons is configured to scan and detect the positioning module 104 that is within certain perimeter in the surrounding area of the respective beacon. The processor 106 is configured to communicate with the positioning module 104 and the beacons 102A-102D, and processes the data retrieved at the positioning module 104 and the beacons 102A-102D to provide the position of the positioning module 104 in relation to the beacons 102A-102D. There are only four beacons 102A-102D are depicted in the examples disclosed herein for convenience of explanation. However, it should be noted that additional beacons can be placed as needed to cover a larger area and to increase the positioning accuracy.

The positioning system 100 of the present disclosure requires the positioning module 104 to receive beacon signals from at least two beacons BC to determine the position of the positioning module 104. In a sense, the area covered by at least two beacon's scanning range defines a block within the targeted area, where the coordinate of the positioning module 104 can be identified. If one of the beacons is positioned too far away from the positioning module 104 and cannot communicate with the positioning module 104, then the positioning system 100 would not be able to determine the position of the positioning module 104 in that area. Accordingly, the beacons 102A-102D should be positioned around the limited area to maximize the area covered by at least two beacons 102, and at the same time, minimize the area where the positioning module cannot receive the beacon signal from at least two beacons. In this disclosure, the area where the positioning module 104 cannot communicate with at least two distinct beacons is referred to as the dead spot.

The positioning of the beacons 102A-102D may vary based on the type of signals used by the positioning module 104 in communicating with the beacons 102A-102D. As will be described in further detail, the positioning system 100 relies on the angle in which the positioning module 104 is located from the beacon (or the angle in which the beacon is positioned from the positioning module 104, vice-versa). Accordingly, the beacon signal 108 should be a type of signal that travels in substantially straight line manner. A direct line of sight may be necessary for the beacon signals 108 between the beacons 102A-102D and the positioning module 104. In this case, the scanning area where the positioning module 104 can determine its position may be limited to the area that provides clear line of sight from the positioning module 104 to at least two of the beacons. In some embodiments, the beacon signal 108 can travel through a wall or other type of obstruction so the beacons BC can identify the angle in which the positioning module 104 is arranged from the beacon 102 even when a direct line of sight is not provided between the beacons 102 and the positioning module 104.

The beacons 102A-102D may be configured to emit the beacon signal 108 constantly, periodically or on an occurrence of a predefined triggering event. For instance, the beacons 102A-102D may be configured to provide the beacon signal 108 continuously during the operation, in every 10 seconds, every 10 meters of movement by the movable object OBJ or when a sensor that monitors the movable object OBJ measures changes to or in the movable object OBJ (e.g., physical impact is sensed by the movable object OBJ).

As will be described in further detail below, the positioning system 100 is configured to determine the angle AG in which the positioning module 104 is positioned in relation to the beacons 102. The coordinates of the beacons 102 are defined by their placement in the designated area. With a coordinate of a beacon 102 and the detected angle AG of the path of the beacon signal 108 from that beacon 102 towards the positioning module 104, the coordinates of the points on the path of a given beacon signal 108 can be identified. The positioning module 104 would be on the path of that beacon signal 108. In other words, the coordinate of the positioning module 104 would be the coordinate of one of the points among the set of points on the path of the beacon signal 108. The coordinates for the set of points on the path of a given beacon signal 108 to the positioning module 104 can be calculated on-the-fly or may be looked-up from a database storing pre-calculated coordinates for the set of points on the path of that beacon signal 108. The positioning module 104 may be on the path of another beacon signal 108 emitted from another beacon 102. The beacon signals 108 from this second beacon BC will intersect with the first beacon signal 108 at the positioning module 104. Accordingly, the coordinate of the intersecting point of the beacon signals 108 will be coordinate of the positioning module 104. In other words, there will be a point with the identical coordinate among the coordinates for the points on the path of the first beacon signal 108A and the coordinates for the points on the path of the second beacon signal 108B, and this point with the identical coordinate is the coordinate of the positioning module 104.

Identifying the coordinate of the points on the path of a given beacon signal 108 can be calculated by the processor 106. In embodiments of the positioning system 100 where the coordinates of the points on the path of a given beacon signal 108 is pre-stored in a database, the processor 106 may be configured to search the database for the coordinate of the intersecting point of multiple beacon signals 108. As shown in FIG. 1, the processor 106 may be a standalone processing system that is provided on a separate network server, which is configured to communicate with the positioning module 104, the set of beacons 102A-102D or with both positioning module 104 and the beacons 102A-102D via various networking means, such as the Internet. In some embodiments, the processor 106 may be integrated with the positioning module 104 or may be integrated with one or more beacons 102A-102D. In other words, the processor 106 is not limited to a single central processing system, but may be provided in some or all of the elements implementing the limited area positioning system 100.

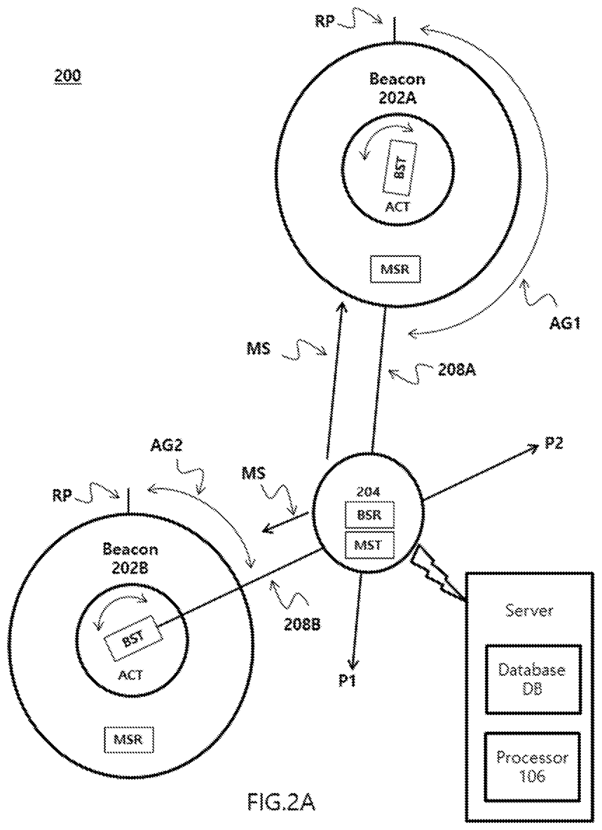

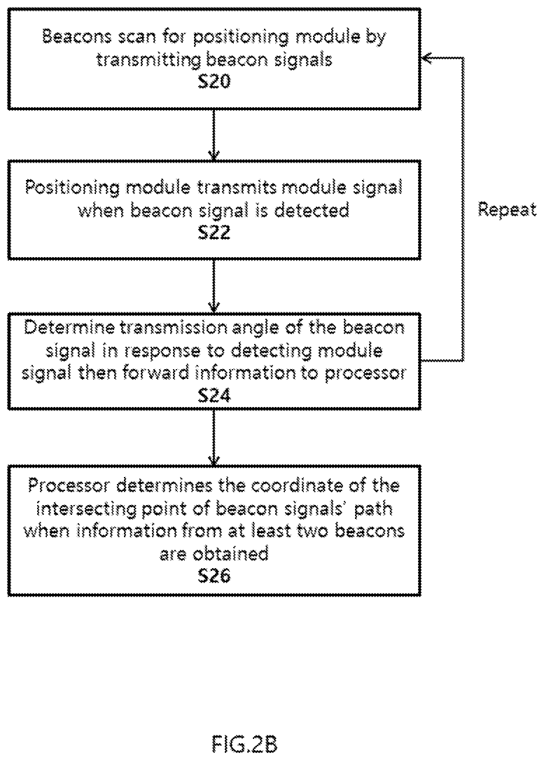

FIG. 2A is a schematic diagram of an exemplary embodiment of a positioning system 200, and FIG. 2B is a flowchart describing an exemplary operation of the positioning system 200. As shown in FIG. 2A, each of the beacons 202A-202B includes a beacon signal transmitter BST and a module signal receiver MSR. The beacons 202A-202B are configured to emit beacon signals 208A-208B, respectively, that is implemented with a type of signal that exhibits directionality (i.e., travels in a specified direction), such as infrared based signal, laser base signal or radio frequency based vertical fan beam signal. In some other embodiments, the beacon signal transmitter BST may be a combination of signal transmitters that emits a first type of beacon signal such as an infrared based signal and a second type of beacon signal such radio frequency based signal.

In this embodiment, each of the beacons 202A-202B is provided with an actuator ACT. The actuator ACT is coupled to the beacon signal transmitter BST so that the angle in which the beacon signals 208A-208B emitted from the beacon signal transmitter BST can be adjusted. For instance, the actuator ACT may be implemented with a stepper motor with a predetermined number of steps in a single revolution. For instance, a stepper motor with 51,200 steps per revolution can be used. In this case, each step represents 0.007 degrees of accuracy.

To scan the positioning module 204, the actuator ACT of the beacon 202 continues to adjust orientation of the beacon signal transmitter BST while the beacon signal transmitter BST emits the beacon signal BS, thereby adjusting the emissive angle of the beacon signal 208A-208B that travels substantially in a straight line.

The positioning module 204 is provided with a beacon signal receiver BSR and a module signal transmitter MST. The beacon signal receiver BSR, as its name implies, is configured to receive the beacon signals 208A-208B emitted from the beacons 202A-202B. The beacon signal 208 from the beacons 202 is implemented with a type of signal that exhibits directionality (i.e., travels in a specified direction), such as infrared based signal, laser base signal or radio frequency based vertical fan beam signal. Accordingly, the beacon signal receiver BSR can be infrared signal receiver, laser signal receiver or a radio frequency signal receiver. In some embodiments of the positioning system, each beacon is configured to emit two different kinds of beacon signals, for instance, as infrared signal and radio frequency based vertical fan beam signal. In such embodiments, the beacon signal receiver BSR may include a plurality of signal receivers compatible with the different kinds of signals emitted from the beacons.

The module signal transmitter MST may be a transmitter that transmits a signal that radiates without a specific directionality, for instance, a radio frequency signal transmitter. The positioning module 204 is configured to emit a module signal MS upon receiving a beacon signal 208 from any one of the beacons 202A-202B. For purposes of explanation, the positioning module 204 is configured to emit a module signal MS when it receives the beacon signal 208A emitted from the beacon 202A. Simply put, a beacon signal 208 activates the positioning module 204 to emit the module signal MS. That is, the positioning module 204 is configured to emit one or more types of module signal MS upon receiving a beacon signal 208 from any one of the beacons 202A-202B.

When the beacon signal 208 is received by the beacon signal receiver BSR of the positioning module 204, the module signal transmitter MST of the positioning module 204 emits the module signal MS. The beacons 202A-202B are configured to stop the actuator's movement when the beacon's module signal receiver MSR receives the module signal MS, and the degree of actuator's movement from the reference position RP until the receipt of the module signal MS would be indicative of the angle AG in which the positioning module 204 is aligned from that beacon 202.

The coordinate of each of the beacons 202A-202B are predefined upon their placement. In conjunction with the angle of the path of beacon signal 208 from the beacon 202 towards the positioning module 204, the coordinates of a set of points along that path of the beacon signal 208 from the respective beacon 202 can be identified. To the extent that the positioning module 204 is within reach of at least two beacons 202, the beacon signals from those two beacons 202 will intersect at the point where the positioning module 204 is located.

Referring to FIGS. 2A and 2B, in step S20, the beacons 202A-202B start to scan for a positioning module 204 by transmitting the beacon signal 208A-208B, respectively. Herein, the actuator ACT provided in each of the beacons 202A-202B rotates the beacon signal transmitter BST of the beacons 202A-202B, thereby scanning the area for the positioning module 204.

In step S22, the positioning module transmits the module signal back to the beacon 202 in response to receiving the beacon signal 208. For instance, the positioning module 204 emits the module signal MS in response to receiving the beacon signal 208A from the beacon signal transmitter BST of the first beacon 202A. In this instance, the module signal MS may be structured so that it is only acceptable by the module signal receiver MSR of the first beacon 202A.

In step S24, the first beacon 202A determines the transmission angle of the beacon signal by calculating the degree of actuator's rotation from the reference point RP upon receiving the module signal MS from the positioning module 204. Then, the first beacon 202A forwards to the processor 206, the beacon's identification as well as the information about the determined transmission angle of the beacon signal 208A from the first beacon 202A.

The steps S20 through S24 are repeated until beacon signals from at least two distinct beacons are received by the positioning module 204. Accordingly, the positioning module 204 emits the module signal MS again in response to receiving the beacon signal 208B from the beacon transmitter BST of the second beacon 202B. In this instance, the module signal MS may be structured so that it is only acceptable by the module signal receiver MSR of the second beacon 202B. Then, the second beacon 202B forwards to the processor 206, the beacon's identification as well as the information about the determined transmission angle of the beacon signal 208B from the first beacon 202B.

In step 26, the processor 206 determines the coordinate of the intersecting point of the beacon signals' path when necessary information is received from at least two distinct beacons. More specifically, the first beacon signal 208A from the first beacon 202A travels towards the positioning module 204 in the first angle AG1, and the second beacon signal 208B from the second beacon 202B travels towards the positioning module 204 in the second angle AG2. The path of the first beacon signal 208A and the second beacon signal 208B is denoted as P1 and P2, respectively. The set of coordinates for the points along the path P1 of the beacon signal 208A may be calculated by the processor 206. Likewise, the set of coordinates for the points along the path P2 of the beacon signal 208B may be calculated by the processor 206. In some embodiments, the set of coordinates for the possible points along the possible paths of the beacon signal from each of the beacons may be pre-calculated and stored in a look-up table for simple retrieval with the beacon's identification and the beacon signal's angle identified upon the receipt of the module signal MS from the positioning module 204. The beacon signal 208A from the beacon 202A along the path P1 and the beacon signal 208B form the beacon 202B along the path P2 intersect each other at the positioning module 204. Accordingly, the processor 206 is configured to identify a coordinate that is present in both the set of coordinates for the points along the path P1 as well as the set of coordinates for the points along the path P2, which will be the coordinate of the positioning module 204.

Although not depicted in FIG. 2A, there may be another beacon that is in direct line of sight with the positioning module 204, and the processor 206 can be configured to search for a coordinate that is present in the set of coordinates for the points along more than two different beacon signal paths (e.g., intersecting point of at least three beacon signals).

It should be noted that the processor 206 may be integrated in the positioning module 204. In this case, the beacons 202A-202B need to provide the angle of the actuator ACT back to the positioning module 204 after the receipt of the module signal MS, and the processor 206 in the positioning module 204 identifies its coordinate from the beacon's identification information and the associated angle information received from at least two beacons.

In some other embodiments, the beacon signals 208 in the scanning stage of the positioning module 204 may be structured such that the beacon signals 208 incorporates information indicative of the actuator's current degree of movement from the reference position RP. That is, the beacon signal 208 may be constantly updated in accordance with the actuator's current position indicative of the beacon signals' transmission angle AG while scanning for the positioning module 204. In this embodiment, it is not necessary for the module signal MS to be provided from the positioning module 204 back to the beacons 202A-202B to stop the actuator ACT nor obtain the angle information via another signals sent by the beacons 202.

The positioning module 204 may be provided with the database DB storing the look-up table of the coordinates that are representative of the possible intersecting points of the beacon signals 208. Alternatively, the positioning module 204 may be provided with a network module to communicate with a network server that includes a database with the look-up table of the coordinates representative of the possible intersecting points of the beacon signals 208 using one or more wireless communication network. The wireless communication network may include, for example, second generation mobile communication networks such as Global System for Mobile communication (GSM), Code Division Multiple Access (CDMA), etc., a mobile internet such as Bluetooth, Wireless Fidelity (Wi-Fi), third generation mobile communication networks such as Wideband Code Division Multiple Access (WCDMA), CDMA2000, etc., fourth generation mobile communication networks such as Long Term Evolution (LTE), LTE-Advanced, and 5th generation mobile communication networks.

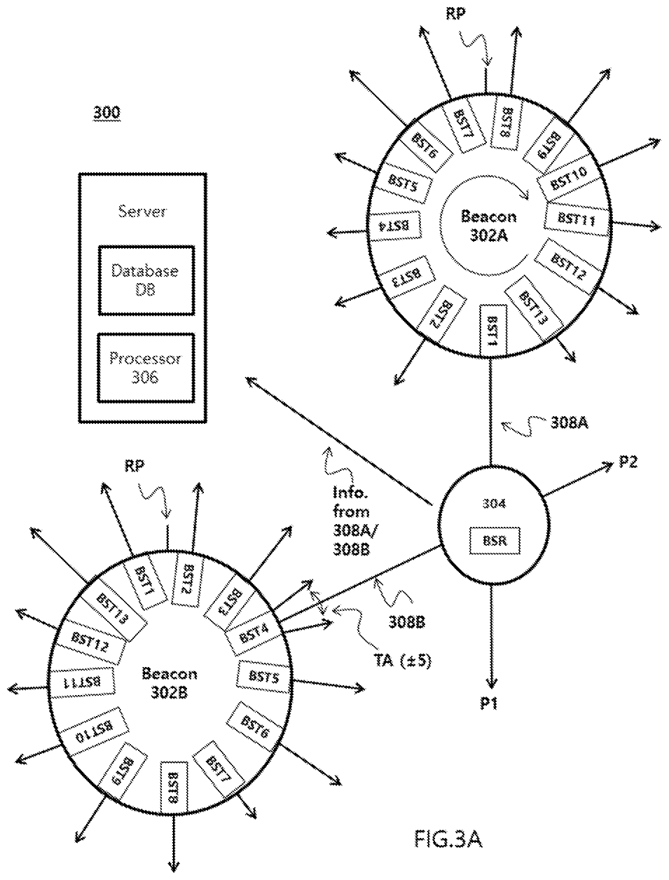

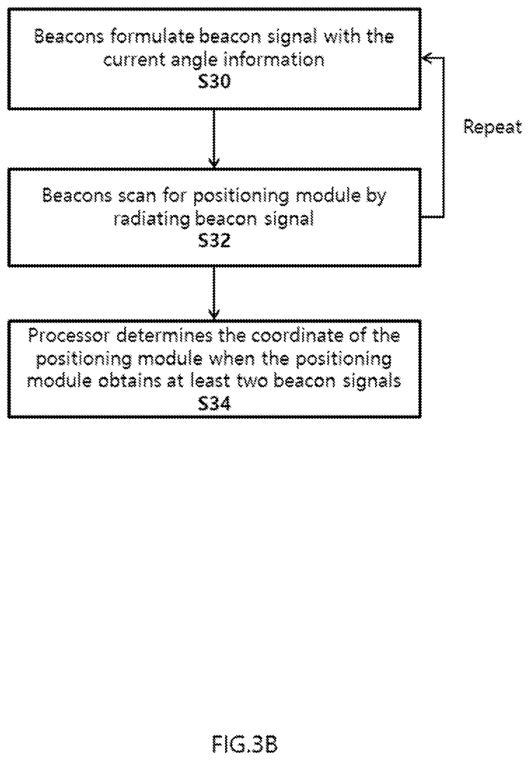

FIG. 3A is a schematic diagram of an exemplary embodiment of a positioning system 300, and FIG. 3B is a flowchart describing an exemplary operation of the positioning system 300. In this embodiment, the positioning system 300 is provided with a plurality of beacons 302A-302B placed around the targeted area to scan for the positioning module 304. Each of the beacons 302A-302B is provided with a plurality of beacon signal transmitters BST. Each beacon signal transmitter BST is arranged to transmit the beacon signal 308 in a non-overlapping predetermined range of degrees. In other words, there can be provided N number of beacons signal transmitters BST in each of the beacons 302A-302B, and each one of the beacon signal transmitters BST are configured to emit the beacon signal in a range of N/360 degrees.

Preferably, each of the beacon signal transmitters BST of a beacon 302 is configured cover less than 1 degree interval. In some embodiments, however, each beacon 302 may be provided with less than 360 beacon signal transmitters BST to reduce the cost and/or to reduce power consumption of the beacon 302. Of course, additional number of beacon signal transmitters BST may be provided to reduce intervals between the angles covered by each of the beacon signal transmitters BST, thereby reducing the spots that are not scanned by the beacon signals 308.

Each of the beacons 302A-302B is provided with an identification code. Each of the beacon signal transmitters BST of the beacon 302 is also provided with an identification code. Accordingly, the beacon signal 308 can be configured to incorporate the beacon's identification code and/or the beacon signal transmitter's identification code. In this embodiment, the transmission angle from the beacon signal transmitter is predefined, and thus the beacon signal transmitter's identification code serves as the data that is indicative of the angle in which the beacon 302 is positioned relative to the positioning module 304. In other words, each beacon transmitter's identification may be associated with a set of coordinates corresponding to a set of points covered by the beacon signal 308 from that particular beacon signal transmitter BST. Rather than indicating the beacon transmitter's identification information in the beacon signal, in some embodiments, the beacon signal 308 may be structured to indicate the beacon signal's transmission angle from the respective beacon 302.

The beacon signal 308 may incorporate the information indicative of the beacon's identification and the beacon signal transmitter's identification. Alternatively, the beacon signal 308 may incorporate the information indicative of the beacon's identification and the transmission angle of the beacon signal from the beacon 302. It should be noted that each beacon 302 is assigned with a predetermined coordinate, and therefore, each of the beacon's identification is associated with a unique coordinate.

The positioning module 304 includes a beacon signal receiver BSR to receive the beacon signals 308A-308B from the beacons 302A-302B. As described above, the beacon signal 308 is unique to a specific beacon signal transmitter BST, which is configured to emit the beacon signal 308 in a predefined range of angles. Accordingly, the beacon signal 308 can be structured to identify the beacon 302 and the beacon signal transmitter BST which the beacon signal 308 is emitted from. A path of the beacon signal 308 from the respective beacon 302 can be determined with the beacon's coordinate in conjunction with the transmission angle AG of the beacon signal 308 from that beacon 302. The positioning module 304 may be configured to communicate with the processor 306 for identifying the coordinate of the positioning module 304 based on the information retrieved from the beacon signals 308 collected by the positioning module 304.

As described above, the coordinates of the points along the path of a beacon signal 308 may be predetermined and stored in a look-up table. When the positioning module 304 receives beacon signals from at least two different beacons 302A-302B, the positioning module 304 can be configured to engage the processor 306 to search for a common point that is present in the path of both of those beacon signals 308A-308B. The common point that is present among the set of points along the paths of those beacon signals is the intersecting point of those beacon signals 308A-308B, and this point can be determined as the location of the positioning module 304.

In some embodiments, the processor 306 may be integrated within the positioning module 304 or otherwise provided within the movable object. The database DB storing the look-up tables for the coordinates of the points along each potential path of the beacon signals 308 from a beacon signal transmitter BST may be provided within the memory of the positioning module, or alternatively, provided in a network server that is accessible by the positioning module via a wireless network.

Referring to FIG. 3A and FIG. 3B, the operation of the positioning system 300 is described. In step S30, beacons 302A-302B formulates the beacon signals 308 so that each beacon signal 308 comprises the information regarding identification of the beacon 302 and the identification of the beacon signal transmitter BST. In some other embodiments, the information regarding the beacon signal's transmission angle may be incorporated in the beacon signal 308. In the example depicted in FIG. 3A, the beacon signal 308A from the beacon signal transmitter BST1 of the beacon 302A is structured so that the signal is indicative of the identification of the beacon 302A and the identification of the beacon signal transmitter BST1. Likewise, the beacon signal 308B is structured so that it comprises information on the identification of the beacon 302B and the identification of the beacon signal transmitter BST4 of that beacon 302B. Other beacon signals 308 emitted from their respective beacon signal transmitters BST are structured to incorporate information regarding the respective beacon 302 and the beacon signal transmitter BST.

As mentioned, the degree in which the beacon signal 308 can be emitted from each individual beacon signal transmitter BST of a beacon 302 is predefined. Therefore, the information on the identification of the beacon 302 and the beacon signal transmitter BST can be easily translated into the transmission angle of the beacon signal 308 associated with such identification information. In some embodiments, however, the beacon signal 308 can be structured in such a way that it provides the raw information, such as the beacon's coordinate and the transmission angle of the beacon signal 308 from that beacon 302 when using the positioning system 300 in a time critical applications (e.g., navigation for automobile).

In step S32, the beacons 302A-302B scan the area for the positioning module 304 by radiating the beacon signal 308 from their beacon signal transmitters BST. Here, the beacons 302A-302B may be configured to radiate the beacon signals 308 from constantly during the operation or in predetermined periodic intervals. The scanning operation of this step S32 is repeated until the positioning module 304 receives at least two beacon signals 308 at its beacon signal receiver BSR.

When the positioning module 304 obtains at least two beacon signals 308A-308B, the positioning module 304 activates the processor 306 to determine the coordinate of the positioning module 304 in step S34.

In this embodiment, the beacon signal may be designed such that it identifies where that beacon signal originates from (i.e., the identification of the beacon as well as the identification of the specific beacon signal transmitter within that beacon). Since each beacon signal transmitter emits the beacon signal only in a predetermined direction (i.e., angle), the identification of the beacon and the identification of the beacon signal transmitter obtained from the beacon signal can indicate the angle in which the beacon is positioned from the positioning module. The beacon's coordinate is already known, and with the emission angle of the beacon signal from that beacon towards the positioning module, the coordinate of the point where the beacon signals from at least two distinct beacons intersect each other (i.e., the coordinate of the positioning module) can be identified.

The processor 306 determines the coordinate of the intersecting point of the beacon signals' path when necessary information is received from the beacons 302A-302B. More specifically, the first beacon signal 308A from the first beacon 302A travels towards the positioning module 304 along the path P1, and the second beacon signal 308B from the second beacon 302B travels towards the positioning module 304 along the path P2.

In performing the step S34, the processor 306 may calculate a set of coordinates for the points along the path P1 of the beacon signal 308A. Likewise, the set of coordinates for the points along the path P2 of the beacon signal 308B may be calculated by the processor 306. In some embodiments, the set of coordinates for the possible points along the possible paths of the beacon signal from each of the beacon signal transmitters BST of the beacons 302 may be pre-calculated and stored in a look-up table for simple retrieval from the database DB by querying the beacon's identification and the beacon signal transmitter's identification. The positioning module 304 may be equipped with a network module, which allows the positioning module 304 to provide information collected from the beacon signals 308A and 308B to the network server where the processor 306 and the database DB is provide.

The positioning module 304 received the beacon signal 308A from the beacon 302A along the path P1 and the beacon signal 308B form the beacon 302B along the path P2, which means they intersect each other at the location where the positioning module 304 is. Accordingly, the processor 306 may identify the coordinate of the common point along the path P1 and the path P2, which will be the coordinate of the positioning module 304.

For increased accuracy, the positioning system 300 can be configured to determine the coordinate of the point where more than two beacon signals intersect each other, for instance three or more beacon signals, as the coordinate of the positioning module 304. The intersecting point of the vector of the beacon signals 308 is the location of the positioning module. A hash map of angles and coordinates of the corresponding intersecting point of the vectors of the beacon signals 308 can be pre-calculated and stored in a database DB (look-up table). Accordingly, the processor 306 can identify the coordinate of the positioning module 304 by querying a set of beacon signal transmitter identifications received by the positioning module.

In some of the embodiments described in FIG. 3A-3B, the beacon signal 308 is structured such that it identifies the beacon 302 as well as the specific beacon signal transmitter BST that emitted the beacon signal 308. The coordinates of the beacons 302A-302B are known, and the identification of the beacon signal transmitter BST1 of the beacon 302A and BST4 of the beacon 302B provides the vector (i.e., transmission angle) of the beacon signals 308A-308B emitted from the respective beacons 302A-302B. In other words, the beacon signal 308A-308B already incorporates the information regarding the angle in which the beacons 302A-302B are positioned relative to the positioning module 304 (in other words, the angle in which the positioning module 304 is positioned relative to the beacons 302A-302B associated with those beacon signals 308A-308B. Here, the positioning module 304 does not need to transmit a module signal back to the beacons 302A-302B for determining the transmission angle of the beacon signals 308A-308B. Moreover, the beacons 302A-302B do not need to wait for the module signal or actively engage in the calculation of a coordinate of a positioning module 304. Instead, the beacons 302A-302B only need to transmit the beacon signals 308 from the beacon signal transmitters BST provided therein, and the coordinate calculation is handled by either the positioning module 304 itself of by a remote server based on the information incorporated in the beacon signals 308 collected by the positioning module 304. This allows for faster scanning of the positioning module while reducing process power consumption.

In some embodiments, each beacon signal transmitter BST may be coupled to an actuator for adjusting the transmission angle TA of the beacon signal 308 from each of the beacon signal transmitter BST. For instance, the actuator may be implemented with a stepper motor with 51,200 steps per revolution can be used to rotate the beacon. In this case, each step represents 0.007 degrees of accuracy. In this way, the entire 360 degrees around each beacon 302 can be scanned with less number of beacon signal transmitters BST. For instance, a beacon signal transmitter BST4 may be configured to emit the beacon signal 60 degrees from the reference point RP. The beacon signal transmitter may be coupled to an actuator that swings the orientation of the beacon signal transmitter ±5 degrees. In this example, the beacon signal transmitter BST4 can cover 55 degrees to 65 degrees from the reference point RP. If the beacon signal transmitter's orientation has changed −3 degrees, then this must be compensated when determining the angle in which the beacon 302B is positioned in relation to the positioning module 304. The amount of swing by the actuator can be considered when incorporating the angle information within the beacon signal 308B. The beacon signal 308B may incorporate the information indicative of the beacon's identification, the beacon signal transmitter's identification as well as the compensation amount (e.g., −3 degrees). Alternatively, the beacon signal 308B may incorporate the information indicative of the beacon's identification and the adjusted angle of the beacon signal 308B from the beacon 302B.

In some embodiments, the beacon itself may be configured to rotate so that the entire 360 degrees around the beacon can be scanned with the beacon signals from the beacon signal transmitters provided therein. For instance, the beacon may be coupled to a stepper motor. By way of example, a stepper motor with 51,200 steps per revolution can be used to rotate the beacon. In this case, each step represents 0.007 degrees of accuracy. In this case, the amount of beacon's rotation should be considered in determining the angle in which the beacon is positioned in relation to the positioning module. In this example, not the individual beacon signal transmitter BST, but the beacon 302 itself may be coupled to an actuator. In this case, the amount of rotation RT of the beacon 302A should be considered when structuring the beacon signal 308A from each of the beacon signal transmitters BST from that beacon 302A. Similar to the previous example, the beacon signal 308A may incorporate the information indicative of the beacon signal transmitter's identification as well as the information regarding the amount of beacon's rotation RT from the reference position RP.

Foregoing instructions and the various data described herein for various applications may be stored in files and transmitted using a variety of computer-readable media. A file in a computing device is generally a collection of data stored on a computer readable medium, such as a storage medium, a random access memory and the likes.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

The term “exemplary” is used herein in the sense of signifying an example, e.g., a reference to an “exemplary widget” should be read as simply referring to an example of a widget.

The adverb “approximately” modifying a value or result means that a shape, structure, measurement, value, determination, calculation, etc. may deviate from an exact described geometry, distance, measurement, value, determination, calculation, etc., because of imperfections in materials, machining, manufacturing, sensor measurements, computations, processing time, communications time, etc.

In the drawings, the same reference numbers indicate the same elements. Further, some or all of these elements could be changed. With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

What is claimed is:

1. A positioning system, comprising:
a plurality of beacons, each of said beacons comprising a module signal receiver and a beacon signal transmitter, said beacon signal transmitter coupled to an actuator that is configured to adjust angle of a beacon signal emitted from the beacon signal transmitter, which travels substantially in a straight line;
a positioning module comprising a beacon signal receiver and a module signal transmitter, said module signal transmitter configured to emit a module signal in response to receiving the beacon signal; and
a processor that is configured to identify angle in which the beacon signal from each of the beacons travels towards the positioning module, and identify an intersecting point of said beacon signals from each of the beacons as a coordinate of the positioning module.

2. The positioning system of claim 1, wherein the beacon signal is one of a radio frequency signal, laser signal or an infrared signal.

3. The positioning system of claim 1, wherein the actuator is a stepper motor configured to rotate the beacon signal transmitter about an axis, which is the respective beacon.

4. The positioning system of claim 1, wherein the module signal includes information capable of identifying the positioning module.

5. The positioning system of claim 4, wherein, when the module signal is received by the module signal receiver, the beacon is configured to record an amount of rotation of the stepper motor, which is indicative of the angle of which the beacon signal travels between the respective beacon and the positioning module.

6. The positioning system of claim 1, wherein the processor is configured to communicate with a database storing a look-up table of coordinates that corresponds to a set of potential intersecting points of the beacon signals emitted from the beacons.

7. The positioning system of claim 6, wherein the processor is provided on a network server, and wherein each of the beacons is provided with a network module to communicate with the network server.

8. The positioning system of claim 7, wherein each of the beacons is configured to provide its unique identification information, unique identification information of the positioning module and the angle of which the beacon signal travels from the respective beacon to the positioning module.

9. The positioning system of claim 6, wherein the processor is provided on a network server, and wherein the positioning module is provided with a network module to communicate with the network server.

10. The positioning system of claim 9, wherein the beacon signal is structured to indicate which beacon the beacon signal is emitted from and the current position of the actuator that is indicative of the angle in which the beacon signal is emitted from the beacon.

11. A positioning system, comprising:
a plurality of beacons, each beacon having a plurality of beacon signal transmitters, wherein each of the beacon signal transmitters is configured to transmit a beacon signal in a predefined angles around the respective beacon; and
a positioning module that is configured to collect at least two distinct beacon signals emitted from the beacon signal transmitter of at least two distinct beacons and to identify a coordinate of the positioning module that correspond to the collected beacon signals.

12. The positioning system of claim 11, wherein each beacon consists of N number of beacon signal transmitters, each of the beacon signal transmitter configured to transmit a beacon signal in a range of 360/N degrees angle.

13. The positioning system of claim 11, wherein each of the beacon signal transmitters of the same respective beacon is configured to emit the beacon signal in a predetermined range of angles that is different from the other beacon signal transmitter of the same respective beacon.

14. The positioning system of claim 11, wherein the beacon signal is representative of an identification code that is associated with the distinct beacon signal transmitter of the positioning system.

15. The positioning system of claim 14, further comprising a coordinate database that stores a set of coordinates, each coordinate corresponding to a combination of identification codes for the beacon signals.

16. The positioning system of claim 14, wherein the coordinate database is provided in a network server, and wherein the positioning module is provided with a network module to send a query to the network server to identify the coordinate corresponding to the combination of identification codes of the collected beacon signals.

17. The positioning system of claim 11, wherein the bacon signal is structure to specify a coordinate of the beacon and an emission angle of the beacon signal.

18. The positioning system of claim 17, wherein the positioning module is configured to calculate a coordinate of an intersecting point of said at least two beacon signals collected by the positioning module.

19. The positioning system of claim 11, wherein the beacon signal is one of a radio frequency signal, laser signal or an infrared signal.

20. The positioning system of claim 11, wherein the plurality of beacon signal transmitters of the same beacon is configured to emit the beacon signals simultaneously.
